(19) United States
(12) Patent Application Publication
(10) Pub. No.: US 2008/0271603 A1
(43) Pub. Date: Nov. 6, 2008

(54) Air purification system and method of purifying air

(75) Inventors: Carl Triplett, Scottsdale, AZ (US); Michael Mathiesen, Scottsdale, AZ (US); Jie Chen, Scottsdale, AZ (US); Geoffrey Faires, Cave Creek, AZ (US)

Correspondence Address: THE DIAL CORPORATION, 15501 N. DIAL BOULEVARD, SCOTTSDALE, AZ, 85260, US

(73) Assignee: The Dial Corporation

(21) Appl. No.: 11/800,311

(22) Filed: May 4, 2007

(51) Int. Cl. B01D 47/02; B01D 47/04; B01D 53/14; F28B 9/00

(52) U.S. Cl. 95/150; 62/172; 95/226; 96/290; 96/329

(57) ABSTRACT

An air purification system and method of purifying air according to various embodiments of the invention includes an ambient air inlet and a purified air outlet for the passage there through of air via a transport line. At least one cleaning chamber configured to contain therein an aqueous solution containing a reactant medium is in fluidic communication with the transport line. The ambient air passes through the at least one cleaning chamber and bubbles through the aqueous solution reacting with the reactant medium contained therein to remove gaseous pollutants and/or particulates. To recharge the system, a user simply changes out the cleaning chamber when the reactant medium is no longer capable of reacting to remove the gaseous pollutants and/or particulates from air passing there through.

### FIELD OF THE INVENTION

The present invention relates to improvements in air purification systems, and more particularly to air purification systems that are adapted to provide purified dry air into an ambient environment and a method of using the air purification systems to purify ambient air.

### BACKGROUND OF THE INVENTION

Many consumers are concerned about the quality of indoor air, and more particularly the presence of odors and/or pollutants that are present in the environment in which they may live and work. Research has found that exposure to particulates and gaseous pollutants commonly present in many indoor air situations, may increase allergies to those exposed, or exacerbate medical breathing conditions. To address this concern, there are numerous air cleaning and/or purifying products on the market that claim to eliminate odors and indoor air pollutants. Many of these products are not effective due to limitations associated with two important performance parameters: selectivity and concentration effect. Current products attempt to clean and/or purify indoor air using a wide-spectrum approach to mask, bind, trap or react with odor and/or pollutant molecules. This one size fits all approach does not allow for specific chemistries to be incorporated into the product to address specific pollutant situations. As a result, only limited interactions are allowed to occur.

In addition, current products are generally designed to work on odors and/or pollutants that are in fabrics or on hard surfaces where relative concentrations of the active ingredient and odor molecules are high and solution or solid reaction chemistries have a high probability of occurring. However, these products are not effective in the ambient air where concentrations are relatively low and the probability of interaction is low. As a result, odor perception (a gas phase mechanism) can easily occur.

In addition, there are numerous mechanical or electrostatic ionizer air cleaning or purifying devices on the market. While they achieve adequate removal of particulate air contaminants, they often fail to be effective on very small particles that may pose a greater concern to the consumers, often in the submicron range.

U.S. Pat. No. 6,843,835 issued to The Proctor & Gamble Company describes an indoor air cleaning apparatus wherein scrubbing liquor is used to clean ambient air that flows from an intake inlet to an outlet for purified air. The ambient air comes in contact with the scrubbing liquor, after which time the scrubbing liquor is discharged from the apparatus via an outlet. The scrubbing liquor must ultimately be removed or discharged from the apparatus taking the contaminants that were in the air with this discharge. A blower is incorporated to draw the ambient air into the apparatus, and flow the air through the system, discharging at the outlet for purified air. As described, the general principle operates by spraying a fine mist of the scrubbing liquor into the air flowing through the system, or other similar means, by which the scrubbing liquor is brought to the malodor.

It should thus be appreciated from the above that it would be desirable to provide an air purification system and method of purifying air that operates by bringing the malodor to the scrubbing product in the form of a self-contained scrubbing liquid chamber where contaminants are held until the chamber is removed and discarded. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

There has now been developed an air purification system according to an exemplary embodiment of the present invention. The air purification system includes an air inlet, an air outlet, at least one transport line, an air pump, and at least one cleaning chamber. The air outlet is in fluidic communication with the air inlet. The at least one air transport line couples the air inlet to the air outlet. The air pump is in communication with the at least one air transport line. The at least one cleaning chamber is configured to contain therein an aqueous solution including at least one reactant medium capable of removing at least one of contaminate particulates and gaseous pollutants from the ambient air. The at least one cleaning chamber is coupled to the at least one air transport line. The air pump circulates the ambient air via the at least one air transport line into the at least one cleaning chamber, thereby dispersing the flow of ambient air into the aqueous solution contained in the at least one chamber and toward the air outlet.

In yet another embodiment there is provided an air purification system comprised of an ambient air inlet, a purified air outlet and at least one transport line coupling the ambient air inlet to the purified air outlet. The system further includes a diaphragm air pump in communication with the at least one air transport line. A first cleaning chamber is configured to contain therein an aqueous solution including at least one reactant medium capable of removing at least one of contaminate particulates and gaseous pollutants from the ambient air and coupled to the at least one air transport line. At least one additional cleaning chamber is configured to contain therein an aqueous solution including at least one reactant medium capable of removing at least one of contaminate particulates and gaseous pollutants from the ambient air and coupled to the first cleaning chamber via the at least one air transport line. The air pump circulates the ambient air via the at least one air transport line into the first cleaning chamber, dispersing the flow of ambient air through the aqueous solution contained therein the first cleaning chamber and toward the at least one additional cleaning chamber, dispersing the flow of ambient air through the aqueous solution contained therein the at least one additional cleaning chamber and toward the purified air outlet.

In a further embodiment, still by way of example only, there is provided a method of purifying air comprising the steps of: drawing in an ambient air at an air inlet; circulating the ambient air thought at least one air transport line via an air pump in communication with the at least one air transport line; flowing the ambient air into at least one cleaning chamber configured to contain therein an aqueous solution including at least one reactant medium capable of removing at least one of contaminate particulates and gaseous pollutants from the ambient air via a gas disparager coupled to the at least one air transport line and thereby converting the ambient air to a purified air, the at least one contaminate particulates and gaseous pollutants remaining dispersed within in the aqueous solution; circulating the purified air toward the air outlet; and exhausting the purified air at an air outlet.

Other independent features and advantages of the improved air purification system and method of cleaning air will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figure, wherein like numerals denote like elements. Additional embodiments of the invention will become evident upon reviewing the non-limiting embodiments described in the specification in conjunction with the accompanying figures, wherein:

FIG. 1 is a schematic diagram of an embodiment of the air purification system and method of the present invention; and

FIG. 2 is a schematic cross-sectional side view of another embodiment of a portion of the air purification system of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, before proceeding with the detailed description, it is to be appreciated that the described exemplary embodiment is not limited to use in conjunction with a specific air purification system or method of use. Thus, although the description is explicitly directed toward an embodiment that is implemented in a specific air handling system, it should be appreciated that it can be implemented in many types of air handling systems, including those known now or hereafter in the art.

The detailed description of exemplary embodiments of the invention herein makes reference to the accompanying figures, which show the exemplary embodiment by way of illustration and its best mode. While the exemplary embodiment is described in sufficient detail to enable one skilled in the art to practice the invention, it should be understood that other embodiments may be realized, and that logical and/or mechanical changes may be made without departing from the spirit and scope of the invention. Thus, the detailed description herein is presented for purposes of illustration only and not by way of limitation.

The invention includes an air purification system and method of purifying ambient air. In an exemplary embodiment, the air purification system is configured to bring a flow of ambient air through a chamber, or vessel, in which a scrubbing liquid, hereinafter referred to as a reactant medium, is contained, and flowing the purified air out of the system.

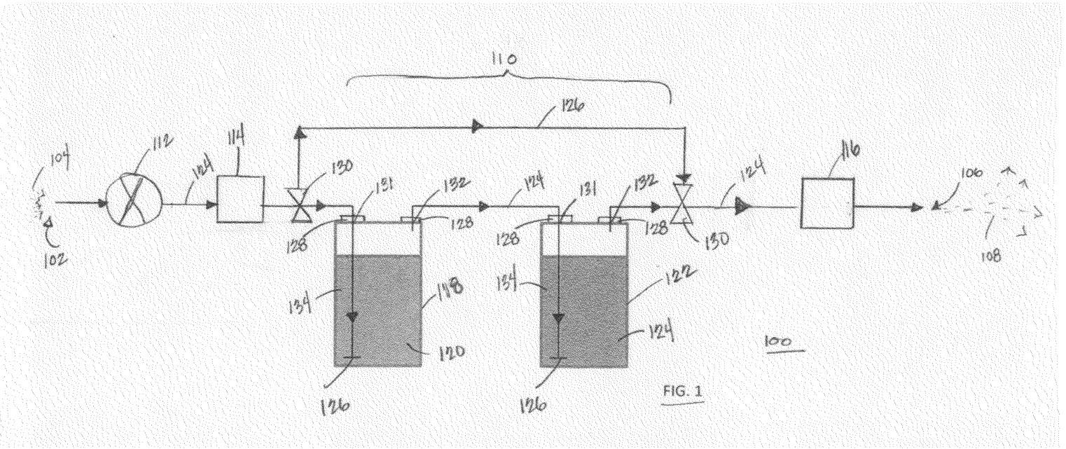

Turning now to the figures, FIG. 1 is a schematic diagram of an exemplary embodiment of an air purification system 100 according to the present invention. The air purification system 100 is generally comprised of a single chamber or multiple chambers that contain a solid, liquid or gas reactant through which ambient air is pumped. More particularly, as illustrated in FIG. 1, the air purification system 100 includes an inlet 102, for the intake of ambient air 104, and an outlet 106, for the outtake of purified or cleaned air 108. In addition, the air purification system 100 includes a cleaning portion 110, including a plurality of chambers 112 through which the ambient air 104 passes. A pump 112 is provided near air inlet 102. The pump 112 is preferably a diaphragm pump well known in the art and serves to pump ambient air 104 through the cleaning portion 110 and toward the purified air outlet 106. It should be understood that although a single pump 112 is illustrated and described, additional similar type pumps may be incorporated in the air purification system 100 when indicated.

As previously stated, the pump 112 is in this exemplary embodiment is a diaphragm pump, well know in the art. The use of a diaphragm pump in the air purification system 100 eliminates the spraying of a cleaning solution into the air flowing through the system in hopes of encountering the airborne particulates. An optional mechanical inlet filter 114, or any other type of particulate filter, may be provided near the air inlet 102 to eliminate any larger particles, e.g. above 3-100μ in diameter, contained in the ambient air 104 from entering the cleaning chambers (described presently). In addition, an optional outlet filter 116, or any other type or particulate filter, may be provided near purified air outlet 106 to eliminate remaining suspended solid and liquid particles, e.g. 0.3-3.0μ in diameter, and particles down to the sub-micron size from the purified air. In a preferred embodiment, the optional outlet filter 116 is an electrostatic-type filter.

In this exemplary embodiment, the cleaning portion 110 includes a first chamber 118, configured to contain therein a first reactant medium 120 in the form of a solid, liquid, or gas reactant dispersed in a solvent through which the ambient air 104 is pumped and a second chamber 122, configured to hold therein a second reactant medium 124 in the form of a solid, liquid, or gas reactant dispersed in a solvent. The reactants mediums 120 and 124 within the first chamber 118 and the second chamber 122, respectively, are preferably contained within an aqueous solution, comprising water as a liquid solvent. Each of the reactant mediums 120 and 124 are designed to target specific classes of particulates. The interaction of the particulates within the ambient air 104 and the reactants contained within the first and second chambers 118 and 122 is enhanced by the distribution of the ambient air 104 as it passes through the reactant mediums 120 and 124. More specifically, a series of air transport lines 124 are configured to transport the ambient air 104 from air inlet 102 through the plurality of components that make up the air purification system 100. As illustrated in FIG. 1, a gas disparager/distributor 126 is provided at a point where the transported ambient air 104 mixes with the reactant mediums 120 and 124 contained within each of the first and second chambers 118 and 122, respectively. Each of the gas disparager/distributor 126 provides for a bubbling action when ambient air 104 enters each of the first and second chambers 118 and 120, thereby enhancing the distribution of the ambient air 104 in the reactant mediums 120 and 124.

As a non-limiting example, in this exemplary embodiment, the first chamber 118 may contain therein the first reactant medium 120 chosen to specifically target acidic malodors (gaseous pollutants) or particulates, such as isovalaric and —SH compounds. To target these specific pollutants and/or particulates, the first reactant medium 120 may include such basic reactants as carbonate, bicarbonate, and/or sodium hydroxide solutions. The second chamber 122 may contain therein the second reactant medium 124 chosen to specifically target basic malodors (gaseous pollutants) or particulates such as amines. To target these specific gaseous pollutants and/or particulates, the second reactant medium 124 may include acids such as acetic acid, malic acid, and citric acid.

During operation, the pump 112 circulates ambient air 104 through the air purification system 100 via the air transport lines 124. Initially, large particulates as previously described may be removed via the optional filter 114. As illustrated, the air purification system 100 may further include a by-pass line 126, so that it is possible to have only a part of the incoming ambient air 104 pass through the cleaning section 110 and contact the reactive mediums 120 and 124. Preferably, this by-pass line 126 is installed downstream the inlet filter 114, if present, but upstream the outlet filter 116, if present. A plurality of optional valves 130 controls bypass of the flow of the ambient air 104 to and from the bypass line 126. The ambient air that is transported through the cleaning portion 110 next enters the first chamber 118 through the gas disparager 126. The gas disparager 126 creates a bubbling of the air passing there through the first reactant medium 120 which rises and exits the first chamber 118 through the transport line 124. This process is repeated through the second chamber 122.

It should be understood that while the air purification system 100 illustrated in FIG. 1 shows only two chambers, it is anticipated that the air purification system 100 may contain any number of chambers configured to contain therein a reactant medium, or other cleaning medium, and configured in series or parallel. For example, in an alternative embodiment, the air purification system 100 may include a third chamber (not shown) configured to contain therein an oxidizer or bleaching agent, such as a chlorine compound generating hypochlorite ions, chlorine dioxide, hydrogen peroxide, percarbonates, borates, and/or permanganate that would destroy particulates and/or gaseous pollutants that come in contact. Additional mediums that may be contained in the first chamber 118, the second chamber 120, or in additional chambers may include, but are not limited to, surfactants, that serve to increase the ability of the reactant medium to solubilize or absorb the particulates and/or gaseous pollutants, sanitizers, biocidals, antibacterial agents, and antimicrobial agents that server to destroy microorganisms, bacteria and viruses, metallic compounds of zinc, copper, silver or iron, organic aldehydes and solvents, solid materials such as activated carbon, zeolites, and baking soda, and/or hydroscopic chemicals such as calcium chloride for humidity control.

In addition, the air purification system 100 of the present invention may include an air enhancer option to impart a fragrance or perfume to the clean air as it exits the series of chambers and re-enters the room environment. More specifically, the air purification system 100 may include an additional chamber configured to contain therein a fragrance medium. Fragrance mediums may include, but are not limited to a scented oil, an aqueous solution/emulsion, a solid matrix, or the like. In an alternate embodiment, it is anticipated that an air enhancer may be included within the first chamber 118 and/or the second chamber 122 in addition to the reactive mediums 120 and 124 contained therein.

Referring again to FIG. 1, the first chamber 118 and the second chamber 122 may each include a means for controlling the reactant medium 120, 124, within their respective chambers, and/or to prevent leakage of the reactant mediums 120 and 124 from within the first chamber 118 and the second chamber 122, respectively. More specifically, as illustrated in FIG. 1, a hydrophobic membrane 128 is included at an entrance port 131 and an exit port 132 of the first chamber 120, and at an entrance port 131 and an exit port 132 of the second chamber 124. The hydrophobic membrane 128 prevents leakage of the reactant mediums 120 and 124 from within the first and second chambers 118 and 122. Additional materials for controlling the reactant medium within its respective chamber includes the use of a layer of sodium polyacrylate, a type of super absorbent polymer (SAP), at the entrance port 130 and exit ports 132 of each chamber, or the inclusion of a sodium polyacrylate powder within the chambers 118 and 122. In addition, when necessary, an anti-foaming agent may be included within the reactant mediums 120 and 124 to prevent excessive foaming during operation.

Depending on the exhaustion degree of the reactant mediums 120 and 124, in this exemplary embodiment, the air purification system 100 further includes an end of use indicator 134. The end of use indicator 134 serves to alert a user that the reactive mediums 120 and 124, and more particularly the active ingredients contained therein the reactive mediums 120 and 124, are consumed and no longer capable of interacting with the ambient air 104 to clean and/or purify the air. In the exemplary embodiment, the end of use indicator 134 is based on changes in the reactant medium pH or other color change chemistry initiated by the interaction of the air particulates with the reactant medium 120 and 124. In addition, in an alternative embodiment, depletion of the reactant mediums through evaporation into the air stream may also be used as the end of use indicator 134. At a time when the end of use indicator 134 alerts the user to the depletion of the reactive mediums 120 and 124, the user would simply replace the chamber 118 or 122 with a new chamber containing new reactive mediums. The use of electronics (e.g. LED lights, timers and control circuits) may be included in the air purification system 100 to indicate and govern the operation of the system 100.

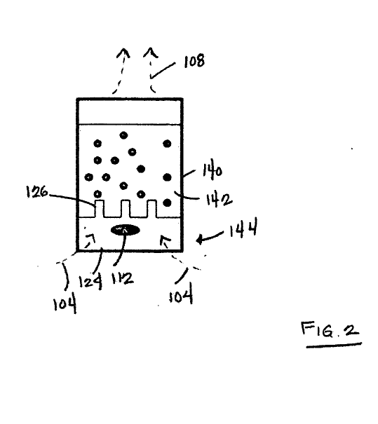

FIG. 2 is a schematic representation illustrating a portion of another non-limiting embodiment of the present invention in which the ambient air 104 enters at or near the bottom surface of the chamber. More specifically, illustrated is a single chamber 140, configured similar to the first chamber 118 of FIG. 1. The single chamber 140 is configured to contain therein a reactant medium 142, generally similar to reactant medium 120 of FIG. 1. In this particular embodiment, the pump 112 is located near a lower portion 144 of the chamber 140. The ambient air 104 is circulated by the pump 112 through a series of circulation lines 124, as previously described. In contrast to the previous embodiment, the ambient air 104 enters the chamber 140 at the lower portion 144. The plurality of gas disparagers 126 coupled to the circulation line 124 provide a bubbling action when the ambient air 104 enters into the chamber 140, contacting the reactant medium 142. Subsequent to passage through the reactant medium 142, the purified or cleaned air 108 exits the chamber 140 as indicated.

The air purification system 100 of the present invention is formed as either a portion of an industrial or residential air cleaning apparatus or as a “stand alone” type of device. When formed as a part of an industrial or residential air cleaning apparatus, it may be part of a heating, ventilation, and or cooling system (HVAC). The system may additionally be included within the HVAC system of a vehicle, such as an automobile or aircraft. When formed as a “stand alone” device, the system is capable of operating without the need to be connected to a source of compressed air or water and the like. The device preferably has a closed flow design, and is self-sufficient, as opposed to industrial air cleaning apparatus. The air purification system 100 may be connected to an electrical wall outlet or operated by a battery power source for greater portability.

Accordingly, disclosed is an improved air purification system and method of use in which gaseous pollutants and/or particulates are brought to a cleaning source. While exemplary embodiments have been presented in the foregoing detailed description of the invention, it should be appreciated that a vast number of variations exist. In addition, benefits, other advantages, and solutions to the problem have been described herein with regard to exemplary embodiments. However, the benefits, advantages, solutions to problems, and any element(s) that may cause any benefit, advantage, or solution to occur or become more pronounced are not to be construed as critical, required, or essential features or elements of any or all the claims or the invention. It should also be appreciated that the exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims.

What is claimed is:

1. An air purification system comprising:
an air inlet;
an air outlet in fluidic communication with the air inlet;
at least one air transport line, coupling the air inlet to the air outlet;
an air pump in communication with the at least one air transport line; and
at least one cleaning chamber configured to contain therein an aqueous solution including at least one reactant medium capable of removing at least one of contaminate particulates and gaseous pollutants from the ambient air and coupled to the at least one air transport line,
wherein the air pump circulates the ambient air via the at least one air transport line into the at least one cleaning chamber, dispersing the flow of ambient air into the aqueous solution contained in the at least one chamber and toward the air outlet.

2. The system of claim 1, further including a mechanical inlet filter positioned between the air inlet and the at least one cleaning chamber.

3. The system of claim 2, wherein the mechanical inlet filter is configured to remove solid particulates having a diameter between 3-100μ.

4. The system of claim 1, further including an outlet mechanical filter positioned between the at least one cleaning chamber and the air outlet.

5. The system of claim 4, wherein the outlet mechanical filter is configured to remove solid particulates having a diameter between 0.3-3.0μ.

6. The system of claim 1, wherein the air pump is a diaphragm air pump.

7. The system of claim 1, wherein the at least one reactant medium is selected from the group of acidic or alkaline agents, anionic and nonionic surfactants, organic solvents, oxidizing agents, bleaching agents, sanitizers, biocidals, antibacterial agents, antimicrobial agents, metallic compounds of zinc, copper, silver or iron, organic aldehydes and solvents, activated carbon, zeolites, baking soda, and hydroscopic chemicals.

8. The system of claim 1, wherein the at least one cleaning chamber further includes a fragrance medium.

9. The system of claim 1, further including an additional cleaning chamber configured to contain therein an aqueous solution including at least one reactant medium capable of removing at least one of contaminate particulates and gaseous pollutants from the ambient air and coupled to the at least one air transport line.

10. The system of claim 1, further including an additional chamber configured to contain therein a fragrance medium.

11. The system of claim 1, wherein the system is formed as a part of a heating, ventilation, and air conditioning (HVAC) system.

12. The system of claim 1, wherein the system is formed as a part of a stand-alone device.

13. The system of claim 1, further including a bypass transport line for the transport of air there through and bypass of the at least one cleaning chamber.

14. An air purification system comprising:
an ambient air inlet;
a purified air outlet;
at least one air transport line, coupling the ambient air inlet to the purified air outlet;
a diaphragm air pump in communication with the at least one air transport line; and
a first cleaning chamber configured to contain therein an aqueous solution including at least one reactant medium capable of removing at least one of contaminate particulates and gaseous pollutants from the ambient air and coupled to the at least one air transport line; and
at least one additional cleaning chamber configured to contain therein an aqueous solution including at least one reactant medium capable of removing at least one of contaminate particulates and gaseous pollutants from the ambient air and coupled to the first cleaning chamber via the at least one air transport line,
wherein the air pump circulates the ambient air via the at least one air transport line into the first cleaning chamber, dispersing the flow of ambient air through the aqueous solution contained therein the first cleaning chamber and toward the at least one additional cleaning chamber, dispersing the flow of ambient air through the aqueous solution contained therein the at least one additional cleaning chamber and toward the purified air outlet.

15. The system of claim 14, further including an inlet particulate filter positioned between the ambient air inlet and the first cleaning chamber and configured to remove solid particulates having a diameter between 3-100μ.

16. The system of claim 14, further including an outlet particulate filter positioned between the at least one additional cleaning chamber and the purified air outlet and configured to remove solid particulates having a diameter between 0.3-30μ.

17. The system of claim 14, wherein the at least one reactant medium is selected from the group of acidic or alkaline agents, anionic and nonionic surfactants, organic solvents, oxidizing agents, photobleaching agents.

18. The system of claim 14, wherein at least one of the first cleaning chamber and the at least one additional cleaning chamber further includes a fragrance medium.

19. The system of claim 14, further including at least one additional cleaning chamber configured to contain therein a fragrance medium.

20. The system of claim 14, further including a bypass transport line for the transport of air there through and bypass of the first cleaning chamber and the at least one additional cleaning chamber.

21. A method of purifying air comprising the steps of:
drawing in an ambient air at an air inlet;
circulating the ambient air thought at least one air transport line via an air pump in communication with the at least one air transport line;
flowing the ambient air into at least one cleaning chamber configured to contain therein an aqueous solution including at least one reactant medium capable of removing at least one of contaminate particulates and gaseous pollutants from the ambient air via a gas disparager coupled to the at least one air transport line and thereby converting the ambient air to a purified air, the at least one contaminate particulates and gaseous pollutants remaining dispersed within in the aqueous solution;
circulating the purified air toward the air outlet; and
exhausting the purified air at an air outlet.

22. The method of claim 21, wherein the step of converting the ambient air to a purified air includes bubbling the ambient air through the aqueous solution to remove the contaminate particulates and gaseous pollutants.
